(19) United States
(12) Patent Application Publication
(10) Pub. No.: US 2025/0109051 A1
(43) Pub. Date: Apr. 3, 2025

(54) ANTISCALANT TREATMENTS FOR WATER THAT IS PROCESSED TO REMOVE ORGANIC CONTAMINANTS

(71) Applicant: CHEMTREAT, INC., Glen Allen, VA (US)

(72) Inventors: Tom GURLEY, III, Richmond, VA (US); Jay Copeland, Richmond, VA (US); Vladimir Djukanovic, Glen Allen, VA (US)

(73) Assignee: CHEMTREAT, INC., Glen Allen, VA (US)

(21) Appl. No.: 18/903,343

(22) Filed: Oct. 1, 2024

Related U.S. Application Data
(60) Provisional application No. 63/541,943, filed on Oct. 2, 2023.

(51) Int. Cl. C02F 5/14; C02F 101/36

(52) U.S. Cl. CPC C02F 5/145; C02F 2101/36

(57) ABSTRACT

Methods for treating a water system to prevent scaling. The water system includes water that is prone to scaling and that is processed to remove an organic contaminant with a GAC system and/or an IX system. Antiscalant compositions can be selected to reduce the amount of antiscalant that is adsorbed or otherwise removed in the contaminant removal system so that a sufficient amount of antiscalant composition remains in the water stream.

### BACKGROUND

Antiscalants are chemical agents that are added to water to reduce or prevent the formation of mineral scale on equipment surfaces that come into contact with the water. Scale can damage and prevent the proper functioning of equipment in water systems such as membranes, filters, metal conduits, tanks, media, beds, etc.

Scale can form when the concentration of scaling minerals in the water exceeds a saturation concentration. This can be a problem in water purification systems such as a RO (reverse osmosis) system, for example, which concentrates minerals and other contaminants in a reject stream. Accordingly, an antiscalant can be added to the feedwater of the RO system in an effort to reduce scaling in the RO equipment as well as downstream equipment, particularly equipment contacting the reject stream.

In some applications, water that is prone to cause scaling is contacted with equipment that is designed to remove organic contaminants from the water, e.g., with granular activated carbon (GAC) beds and/or ion-exchange (IX) beds. For example, an RO reject stream can be treated with a GAC system to remove organic contaminants such as per- and polyfluoroalkyl substances (PFAS) from the water, which are associated with negative health effects in humans.

It has been discovered in connection with this disclosure that existing antiscalant treatments are not effective to prevent scaling in such contaminant removal systems.

### SUMMARY

In particular, the inventors discovered that the contaminant removal systems, such as GAC and IX, can inadvertently remove substantial amounts of common antiscalants from the water. Thus, if the water has concentrated minerals or is otherwise prone to scaling, e.g., as in an RO reject stream, the inadvertent removal of the antiscalant by the GAC and/or IX can cause significant scaling in that equipment.

In one aspect, this disclosure provides methods for treating a water system to prevent scaling in the water system. The water system includes (a) a water stream that (i) has a saturation index of greater than 1 with respect to a scaling mineral; and (ii) includes an organic contaminant; (b) a granulated activated carbon (GAC) bed that contacts the water stream to remove the organic contaminant; and (c) an ion exchange (IX) bed that also contacts the water stream to remove the organic contaminant. The treatment method includes combining at least a first antiscalant and a second antiscalant with the water stream, in which the first antiscalant has a characteristic GAC adsorption that is less than 50% and wherein the second antiscalant has a characteristic IX adsorption that is less than 60%, as those terms are defined below.

In another aspect, this disclosure provides a method for treating a water system to prevent scaling in the water system. The water system includes (a) a reverse osmosis (RO) system that treats a feedwater stream to produce an RO permeate stream and an RO reject stream with at least one an organic contaminant; and (b) a contaminant removal system that treats the RO reject stream to remove the organic contaminant. The contaminant removal system includes at least one of a granulated active carbon (GAC) bed and an ion exchange (IX) bed. The treatment method includes combining an antiscalant composition with the RO reject stream, wherein the antiscalant composition includes at least one antiscalant that has at least one of (i) a characteristic GAC adsorption that is less than 25%, and (ii) a characteristic IX adsorption that is less than 50%, as those terms are defined below.

### BRIEF DESCRIPTION OF THE DRAWINGS

FIG. 1 is a schematic diagram of a water treatment system according to one embodiment;

FIG. 2 is a schematic diagram of a water treatment system according to another embodiment; and

FIG. 3 is a graph illustrating the adsorption of antiscalants in contaminant removal systems.

### DETAILED DESCRIPTION OF EMBODIMENTS

This disclosure relates to improved antiscalant compositions and treatment methods that are effective to reduce scaling in water that is processed to remove organic contaminants, such as with GAC and/or IX systems. As described below, the antiscalant composition that is used can be selected so that the antiscalant compound or compounds are less susceptible to being adsorbed or removed in the contaminant removal system.

The antiscalant treatment is useful in any waters that are prone to scaling, which can include industrial process water, wastewater, cooling water, etc. The water that is treated is typically more than 75 wt. % water or more than 95 wt. % water, for example. The water can include (i) at least one scalant or scaling mineral that is present in concentrations such that the water has a Langelier Saturation Index (LSI) that is from 0 to 3; and (ii) includes at least one organic contaminant.

The scaling mineral that is present in the water can include, for example, calcium scalants such as calcium carbonate, calcium chloride, calcium sulfate, calcium phosphate, magnesium scalants such as magnesium chloride and struvite, barium scalants such as barium sulfate, strontium scalants such as strontium sulfate, iron scalants such as magnetite, and silicate and silica scalants. Any water source can be prone to scaling when one of the scaling minerals is present in amounts such that the water has an LSI of from 0 to 3, over 1, e.g., between 1-3 or 1-2. The water that is prone to scaling can have a total dissolved solids amount that is in a range of 100-100,000 mg/L, from 5,000-75,000 mg/L, or from 30,000-50,000 mg/L. These saturation index values and TDS values can be present in water streams that have been concentrated, e.g., in an RO reject stream.

The organic contaminant that is present in the water can include organohalogen compounds with multiple halogen atoms, including organofluorine compounds such as PFAS. The organic contaminant can be present in the water to be treated in amounts of 5 parts per quadrillion (ppq) to 1,000 ppm, from 1 ppb to 100 ppm, or from 1 ppm to 10 ppm, for example.

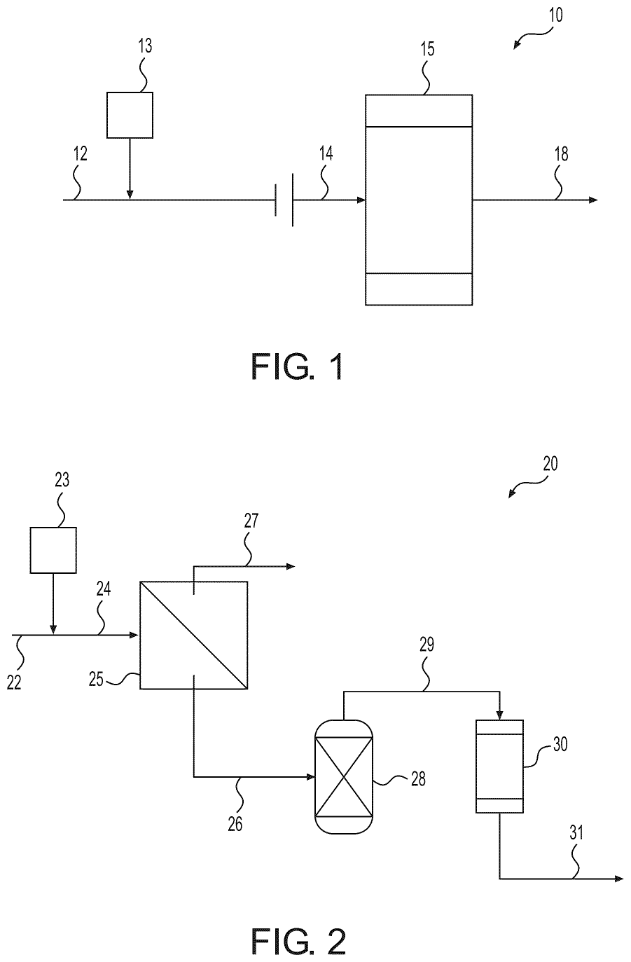

In one aspect, the antiscalant treatment composition can be selected based on (i) the type of contaminant removal equipment that treats the water to remove the organic contaminant, and (ii) the type of scaling minerals in the water. This is described in detail below in connection with FIGS. 1-3.

FIG. 1 is a schematic diagram illustrating a generalized water treatment system 10 in which a water stream 14 has a saturation index of over 1 with respect to at least one scaling mineral and includes an organic contaminant. The water stream 14 is fed to a contaminant removal system 15, such as either GAC or IX, to produce a purified water stream 18. Feedwater stream 12 is dosed with an antiscalant composition from dosing unit 13. The antiscalant composition includes at least one antiscalant. The water stream 14 is downstream of the dosing unit 13 and includes the antiscalant, but may otherwise be the same as feedwater stream 12. Alternatively, water stream 14 can represent a portion of feedwater stream 12 after feedwater stream 12 is subject to one or more processes, which are not illustrated. For example, after the feedwater stream 12 is dosed with the antiscalant composition, it can be sent to filtration or purification equipment which produces water stream 14.

FIG. 2 is a schematic diagram illustrating a water treatment system 20 that includes an RO purification system 25, a GAC contaminant removal system 28, and an IX contaminant removal system 30. In this system, feedwater stream 22 is dosed with an antiscalant composition from dosing unit 23 and then the dosed feedwater stream 24 is sent to the RO system 25. The antiscalant (i.e., active compound(s)) can be added to the RO feedwater in amounts of from 0.05 to 20 ppm, from 0.1 to 10 ppm, or from 1 to 5 ppm, for example. The RO system 25 can include one or a plurality of RO membrane units in series or parallel that produces a purified permeate stream 27 and a concentrates or reject stream 26. The reject stream 26 may have a TDS concentration that is 2 to 10 times or 3 to 8 times higher than the feedwater stream 24. In this case, the reject stream 26 is prone to scaling and includes PFAS contaminants in amounts that are above regulatory limits for wastewater. The reject stream 26 is then passed through a GAC system, which may include one or a plurality of GAC beds (e.g., arranged in series) that are effective to adsorb PFAS present in the water so that stream 29 exiting the GAC system has a lower concentration of PFAS. The stream 29 exiting the GAC system 28 can be fed to an IX system 30, which may include one or a plurality of IX beds (e.g., arranged in series) that remove PFAS with an ion exchange resin to produce an effluent stream 31 that has low levels of PFAS (e.g., less than 100 ppt, less than 50 ppt, or less than 5 ppt). For PFAS removal, the ion exchange resin can be a polymer with anionic tributyl amine groups. In alternative embodiments, the IX system and the GAC system could be swapped so that the IX system is located immediately upstream of the GAC system. Also, as shown in FIG. 1, in some embodiments the GAC system can be used as the sole organic contaminant removal system, or the IX system can be used as the sole organic contaminant removal system.

As an alternative to the arrangement illustrated in FIG. 2, the dosing unit 23 could dose the antiscalant composition in either or both of streams 26 and 29. If fed to the RO reject stream, the antiscalant (active compound(s)) can be added in amounts of from 0.25 ppm to 20 ppm, from 0.5 ppm to 10 ppm, or from 1 ppm to 6 ppm, for example. Also, where multiple antiscalants are used, certain ones of the antiscalants can be fed upstream of the GAC system and certain other ones of the antiscalants can be fed upstream of the IX system but downstream of the GAC system. Nonetheless, the arrangement shown in FIG. 2 is advantageous because the antiscalant composition in inventive embodiments can be dosed at a single location, upstream of the RO system, which can effectively prevent scaling in the RO membranes, in the GAC system, in the IX system, and any intervening conduits or equipment.

As indicated above, the inventors discovered that in systems where water that is prone to fouling is treated with a contaminant removal system to remove organic contaminants, conventional antiscalant treatments were failing because the antiscalant was being adsorbed or removed by the contaminant removal system. This caused scale on the equipment of the contaminant removal system, which is problematic and costly because it lowers the life of the equipment. Accordingly, in aspects of the disclosure, an antiscalant treatment composition can be selected so that it not only prevents scaling based on the type of scale minerals are present in the water, but also so that the antiscalant is not substantially neutralized by being adsorbed or otherwise removed from the water by the contaminant removal system. Likewise, where two different types of contaminant removal systems are used together (e.g., IX and GAC), a plurality of antiscalants can be used in combination.

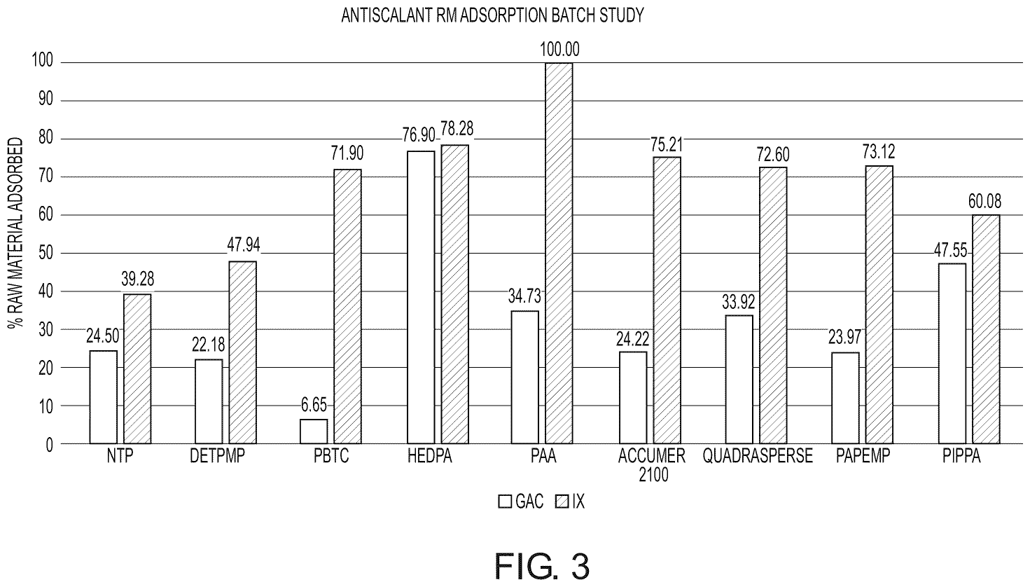

FIG. 3 shows the results from a series of experiments in which several antiscalants are tested to determine how susceptible the antiscalants are to being removed by GAC and IX. These tests are used to define these properties of the antiscalant which are referred to herein as a “characteristic GAC adsorption” where GAC is used in the test and as a “characteristic IX adsorption” where IX is used in the test. The test procedures are described below:

Part I—Adsorbent preparation: Granular activated carbon or ion exchange resin adsorbent media is added to a filter funnel and rinsed with water that is purified via reverse osmosis. The GAC is AGC-40-PFx (ResinTech, Inc.) and the IX media is (SIR-110-MP-HP (ResinTech, Inc.). The adsorbent is allowed to dry out for 2 minutes in the filter funnel before it is transferred to a separate container. The adsorbent is then allowed to dry for 48 hours at room temperature, which ensures each media has a consistent water content prior to batch testing.

Part II—Adsorption Isotherm Experiment: An anion solution is created and a cation solution is created separately. The cation solution was produced by adding calcium sulfate, calcium chloride, and magnesium chloride to RO water to yield the following concentrations: 906 ppm calcium, 422 ppm sulfate, 204 ppm chloride, 326 ppm sodium, and 53.34 ppm magnesium. The anion solution was produced by adding sodium bicarbonate to RO water to yield 707 ppm sodium bicarbonate. Then, 25 g of the cation solution is added to a beaker, followed by dosing the antiscalant (active) at 3.5 ppm. (In the examples of FIG. 3, experiments were conducted varying the dosage of each active antiscalant from 1 ppm to 6 ppm—NTP: 2.5, 4.5, 6.0 ppm; DETPMP: 2.5, 4.25, 6.0 ppm; PBTC: 1.5, 3.0, 4.50 ppm; HEDPA: 2.0, 4.0, 6.0 ppm; PAA: 2.0, 4.0, 6.0 ppm; Acumer® 2100:1.0, 2.0, 3.0 ppm; Quadrasperse®: 1.0, 2.0, 3.0 ppm; PAPEMP: 2.0, 4.0, 6.0 ppm; PIPPA: 2.0, 4.0, 6.0 ppm—and the depicted values represent an average of all of the dosages tested). The solution is mixed at 200 RPM for five minutes at room temperature. Next, 25 g of anion solution is added and mixed for an additional five minutes at 200 RPM. Next, 50 mg of the prepared adsorbent media (either GAC or IX) and 50 g of the mixed anion-cation solution is added to a separate bottle. The bottle is then added to a New Brunswick Scientific Excella E24 Shaker for 48 hours and allowed to shake at 200 rpm and 77 F. The above procedure is also used for control samples without adsorbent media, and the baseline value from the control sample is subtracted from the measured value. After 48 hours samples were filtered through 0.22 um PVDF filters. The filtrate is analyzed for residual antiscalant concentration, and the characteristic antiscalant adsorption property is calculated as a percentage of the originally dosed antiscalant that remains in the adsorbent media. The phosphonate based antiscalants are quantified by undergoing phosphonate digestion and then measurement via ion chromatography. The polymeric antiscalants, including PAA, Acumer® 2100, and Quadrasperse®, were measured via PolyTrak.

The antiscalants tested in FIG. 3 include nitrilotrimethylphosphonic acid (NTP), diethylenetriamine penta (methylene phosphonic acid) (DETPMP), 2-phosphonobutane-1,2,4-tricarboxylic acid (PBTC), 1-hydroxy ethylidene-1,1-diphosphonic acid (HEDPA), polyacrylic acid (PAA) with a M_{w} of 2,000 (Dow), a carboxylate/sulfonate copolymer with a M_{w} of 11,000 (Acumer® 2100; Dow), a sulfonated copolymer with a M_{w} of 10,000 (Quadrasperse®; Chemtreat, Inc.), a polyamino polyether methylene phosphonic acid (PAPEMP), and a poly isopropenyl phosphate (PIPPA).

Since the test water produced is believed to be prone to calcium scaling (e.g., calcium carbonate) the first basis for selecting the antiscalants is that they are effective to prevent calcium-based scale. Second, each of the antiscalants tested in FIG. 3 are compatible with RO membranes because they carry a negative or slightly negative charge such that they do not bind to the membrane. Thus, these antiscalants could be fed upstream of the RO system. Conversely, positively charged antiscalants can bind to RO membranes, which can plug the membrane pores and reduce flow through the RO system.

The characteristic GAC adsorption and characteristic IX adsorption are identified in FIG. 3 for each antiscalant, and are also shown in the Table below.

| Antiscalant | GAC adsorption (%) | IX adsorption (%) |
|---|---|---|
| NTP | 24.5 | 39.28 |
| DETPMP | 22.18 | 47.94 |
| PBTC | 6.65 | 71.90 |
| HEDPA | 76.90 | 78.28 |
| PAA | 34.73 | 100 |
| Acumer ® 2100 | 24.22 | 75.21 |
| Quadrasperse ® | 33.92 | 72.61 |
| PAPEMP | 23.97 | 73.12 |
| PIPPA | 47.55 | 60.08 |

Lower values are preferred for the characteristic GAC adsorption and characteristic IX adsorption since it indicates that the contaminant removal system will adsorb or remove less of the antiscalant from the water system, and therefore more antiscalant will remain in the water to prevent scale from forming.

In general, the nonpolymeric, phosphonate-based antiscalants (NTP, DETPMP, PBTDC, and HEDPA) tend to have better adsorption properties that the polymeric antiscalants although HEDPA has relatively poor results. Additionally, it can be seen that certain antiscalants have good GAC adsorption properties but do not necessarily have good IX adsorption properties.

The antiscalant compositions can be chosen in part based on the type of contaminant removal system in the water stream. Where a GAC bed is used in the water system, the antiscalant composition can include an antiscalant with a characteristic GAC adsorption that is less than 50%, less than 25%, or less than 10%, such as from 1% to 10%, for example. Where an IX bed is used in the water system, the antiscalant composition can include an antiscalant with a characteristic IX adsorption that is less than 60%, less than 50%, or less than 40%, such as from 20% to 40%, for example. Where both a GAC bed and an IX bed are used in combination in a water system, the antiscalant composition can include at least two different antiscalants, where a first antiscalant has the aforementioned values for characteristic GAC adsorption and a second antiscalant has the aforementioned values for the characteristic IX adsorption. Thus, in the system shown in FIG. 2, an antiscalant composition that includes a combination of PBTC and NTP can be used since the PBTC has good GAC adsorption properties and the NTP has good IX adsorption properties.

When two or more antiscalants are used together in the antiscalant composition, they can be provided as a blend and dosed together into the water system or they can be dosed separately. Generally, the two different antiscalants (e.g., PBTC and NTP) can be added in relative weight ratios of 1:5 to 5:1, 1:3 to 3:1, or 1.5:1 to 1:1.5 (i.e., the ratio of an antiscalant that has relatively better GAC adsorption properties to the ratio of an antiscalant that has relatively better IX adsorption properties). Each antiscalant can be present in the antiscalant composition in amounts of from 1 to 50 wt. %, from 2 to 25 wt. %, or from 5 to 15 wt. %, for example, with the balance being inactive components.

In addition or as an alternative to the specific antiscalants enumerated above, other suitable antiscalants can be used provided that they prevent scaling for the particular water and have good GAC and/or IX adsorption properties. Suitable antiscalants are generally organic compounds containing sulphonate, phosphonate, and/or carboxylic acid functional group, and may be polymeric or non-polymeric.

It will be appreciated that the above-disclosed features and functions, or alternatives thereof, may be desirably combined into different methods, compositions, and systems. Also, various alternatives, modifications, variations or improvements may be subsequently made by those skilled in the art. As such, various changes may be made without departing from the spirit and scope of this disclosure.

What is claimed is:

1. A method for treating a water system to prevent scaling in the water system, the water system comprising (a) a water stream that (i) has a Langelier Saturation Index (LSI) of from 0 to 3 with respect to a scaling mineral; and (ii) includes an organic contaminant; (b) a granulated activated carbon (GAC) bed that contacts the water stream to remove the organic contaminant; and (c) an ion exchange (IX) bed that also contacts the water stream to remove the organic contaminant, the method comprising:
combining at least a first antiscalant and a second antiscalant with the water stream, wherein the first antiscalant has a characteristic GAC adsorption that is less than 50% and wherein the second antiscalant has a characteristic IX adsorption that is less than 60%.

2. The method of claim 1, wherein the water stream includes a reject stream of a reverse osmosis (RO) system.

3. The method of claim 2, wherein the first antiscalant and the second antiscalant are added to the water system in feedwater of the RO system.

4. The method of claim 3, wherein the first antiscalant and the second antiscalant are added to the feedwater of the RO system as a blend.

5. The method of claim 1, wherein the organic contaminant is PFAS, which is present in the water stream in an amount of 5 ppq to 1,000 ppm.

6. The method of claim 1, wherein the first antiscalant has a characteristic GAC adsorption that is less than 25%.

7. The method of claim 1, wherein the second antiscalant has a characteristic IX adsorption that is less than 50%.

8. The method of claim 1, wherein the first antiscalant is a first non-polymeric phosphonate-based compound and the second antiscalant is a second non-polymeric phosphonate-based compound.

9. The method of claim 8, wherein the first antiscalant is phosphonobutane-1,2,4-tricarboxylic acid (PBTC).

10. The method of claim 8, wherein the second antiscalant is nitrilotrimethylphosphonic acid (NTP).

11. The method of claim 1, wherein the first antiscalant is phosphonobutane-1,2,4-tricarboxylic acid (PBTC) and the second antiscalant is nitrilotrimethylphosphonic acid (NTP).

12. The method of claim 1, wherein the GAC bed treats the water stream upstream of the IX bed.

13. A method for treating a water system to prevent scaling in the water system, the water system comprising (a) a reverse osmosis (RO) system that treats a feedwater stream to produce an RO permeate stream and an RO reject stream, wherein the RO reject stream includes an organic contaminant; and (b) a contaminant removal system that treats the RO reject stream to remove the organic contaminant, the contaminant removal system comprises at least one of a granulated active carbon (GAC) bed and an ion exchange (IX) bed, the method comprising:
combining an antiscalant composition with the RO reject stream, wherein the antiscalant composition comprises at least one antiscalant that has at least one of (i) a characteristic GAC adsorption that is less than 25%, and (ii) a characteristic IX adsorption that is less than 50%.

14. The method of claim 13, wherein the organic contaminant comprises PFAS.

15. The method of claim 14, wherein the PFAS is present in the RO reject stream in an amount of 1 ppb to 100 ppm.

16. The method of claim 13, wherein the antiscalant composition comprises a first antiscalant that has a characteristic GAC adsorption that is less than 25%, and a second antiscalant that has a characteristic IX adsorption that is less than 50%.

17. The method of claim 13, wherein the at least one antiscalant is selected from the group consisting of phosphonobutane-1,2,4-tricarboxylic acid (PBTC) and nitrilotrimethylphosphonic acid (NTP).

18. The method of claim 13, wherein the antiscalant composition is combined with the RO reject stream by adding the antiscalant composition to the feedwater stream.
